(19) United States
(12) Patent Application Publication
(10) Pub. No.: US 2009/0157479 A1
(43) Pub. Date: Jun. 18, 2009

(54) Selection and Shopping System Founded on Mobile Architecture

(75) Inventors: Moses C. Caldwell, Cambridge, MA (US); Robert Chicoski, Dorchester, MA (US); Greg James, Milwaukee, WI (US); John Opferkuch, San Diego, CA (US)

Correspondence Address: THOMAS P O'CONNELL, 1026A MASSACHUSETTS AVENUE, ARLINGTON, MA, 02476, US

(73) Assignee: BCA Mobile Solutions, Inc., Dorchester, MA (US)

(21) Appl. No.: 12/168,064

(22) Filed: Jul. 3, 2008

Related U.S. Application Data
(60) Provisional application No. 60/947,924, filed on Jul. 3, 2007.

(51) Int. Cl. G06Q 30/00; G06F 17/30; G06F 17/40

(52) U.S. Cl. 705/10; 705/27; 707/3; 707/104.1; 707/E17.014; 707/E17.044

(57) ABSTRACT

A selection and shopping system for providing item recommendations from an inventory of items. The method provides search results based on individualized user characteristics by retaining an inventory of items available for purchase, attributing identifying data to each of the inventory of items, obtaining individualized profile data from each of a plurality of users, retaining the individualized profile data from each of the plurality of users, accepting through remote electronic communication a search query from a user device regarding the inventory of items available for purchase, determining a correspondence between items available for purchase and the search query based on the individualized profile data wherein the step of determining a correspondence between Items available for purchase and the search query based on the individualized profile data is powered by a recommendation engine, and providing a search result from the recommendation engine comprising a display on the user device of items from the inventory of items that have a correspondence with the search query and the individualized profile data.

### FIELD OF THE INVENTION

The present invention relates generally to computing systems and methods. More particularly, disclosed and protected herein is a web and mobile compliant software system under which personalized consumer profiles are exploited to enable the selection and purchase of goods and services in an individualized manner.

### BACKGROUND OF THE INVENTION

The rapid development of Internet and mobile technology has fundamentally changed the way in which personal and business transactions can be conducted. For example, in a remarkably short time span, computing systems have transitioned from exclusively business tools to home computing and then to portable laptops and, now, to handheld mobile devices with sufficient memory, power, and communication capabilities to enable product research and purchasing on a mobile basis.

Furthermore, wireless technology has made consumer access to products and services still more convenient and portable. Laptops, personal digital assistants, and advanced mobile devices have combined with WiFi connections to make it possible to access goods and services via the Internet at substantially any time, including while traveling for pleasure or business. For example, 3G and forthcoming 4G technology have enabled mobile devices to provide full access to the Internet in the palm of a user's hand. As a result, mobile devices function as multi-faceted tools, operable not only for interpersonal communication but also as wireless wallets, remote controls, and pathfinders thereby placing the global marketplace in the palm of a user's hand.

Prior art systems and methods have enabled consumers to employ personal computers with access to the Internet to enter clothing preferences and requirements and to receive clothing options in response based thereon. Further systems of the prior art have enabled registered users to receive particularized electronic mail updates from web retailers, such as when preferred items are about to be placed on sale.

Further web sites are accessible by personal computer that provide robot searching capabilities, commonly referred to as bot services. The bot can undertake repetitive, otherwise time-consuming tasks, such as searching websites and news groups for information and indexing sites and listings in databases or automatic record-keeping systems. With this, a shop bot can search the web for the lowest price for a particular item and can return a listing of web sites selling the item and the respective prices.

Under the current state of the art, however, the options for employing a mobile communications device for undertaking personalized shopping searches are severely limited. While mobile communications devices have become increasingly powerful over the recent past, the prior art apparently lacks the ability to enable a user of such a device to obtain individualized guidance as to apparel choices matching predetermined user preferences while also potentially advising regarding product availability and enabling the selective purchase of individualized. available products in a mobile format.

### SUMMARY OF THE INVENTION

In light of the state of the art summarized above, the present invention is founded on the basic object of providing a system under which personalized consumer profiles and preferences can be exploited to enable the selection and purchase of apparel and other goods and services in an individualized manner.

A more particular object of embodiments of the invention is to provide a system wherein a user can obtain recommendations of multiple articles from diverse retailers based on a consumer's profile and, additionally or alternatively, based on individualized search criteria.

Another particular object of embodiments of the invention is to provide a system that is readily operable on mobile devices thereby to convenient and readily accessible access to the same.

A further object of manifestations of the invention is to enable order, payment, and delivery arrangements to be made directly through systems as taught herein.

Still another object of the invention is to provide a system capable of retaining information to establish a virtual collection record of a consumer's possessed goods or services and, potentially, to provide recommendations and options for supplementing the same.

These and in all likelihood further objects and advantages of the present invention will become obvious not only to one who reviews the present specification and drawings but also to those who have an opportunity to experience an embodiment of the selection and ordering system disclosed herein in practice. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

In carrying forth the foregoing objects, a basic embodiment of the invention can comprise a web and mobile compliant software system under which personalized consumer profiles can be exploited to enable the selection and purchase of apparel and other goods and services in an individualized manner. The system can be arranged in three tiers. A first tier can comprise a graphic user interface. which can provide a login screen for allowing the client to access and manipulate his or her profile. The profile can include a client's personal information and style preferences. To form the profile, a client can complete a Personal Assessment Form (PAF) within which a client develops, assesses, and establishes a record of his or her personal style. A second tier of the system can use software logic to manipulate a client's input data and to match items from appropriate retailers to the client's profile preferences. The system can include a virtual collection record or virtual wardrobe in the case of apparel to maintain client inventory and a virtual shopping cart to process orders. A third tier of the system can store all information within a client's profile that the second tier requires to process client requests. The entire process enables a client to search, access, and purchase clothing and potentially other goods and services that match his or her personal style.

One will appreciate that the foregoing broadly outlines certain goals of the invention to enable a better understanding of the detailed description that follows and to instill a better appreciation of the inventors' contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

In the accompanying drawing figures:

FIG. 1 is a schematic view of a selection and shopping system pursuant to the invention disclosed herein;

FIG. 2 is a screen shot depicting a login screen for a system pursuant to the present invention;

FIG. 3 is a screen shot of the results of a personalized apparel search conducted employing a system under the instant invention;

FIG. 4 is a screen shot depicting a search result pursuant to a personalized apparel search in conjunction with a plurality of coordinated apparel items;

FIG. 5 is a screen shot of a checkout screen for enabling the purchase of an item under the present invention;

FIG. 6 is a more detailed schematic depiction of a selection and shopping system according to the invention;

FIG. 7 is a social attribute vector diagram;

FIG. 8 is a Personal Preference Questionnaire usable under the present system;

FIG. 9 is a Physical Profile and Preference Data form as taught hereunder: and

FIGS. 10A through 10C are schematic views of programming operations under an embodiment of the system disclosed herein.

### DETAILED DESCRIPTION OF PREFERRED EMBODIMENTS

It will be appreciated that the selection and shopping systems disclosed herein are subject to widely varied embodiments. However, to ensure that one skilled in the art will be able to understand and, in appropriate cases, practice the present invention, certain preferred embodiments of the broader invention revealed herein are described below and shown in the accompanying drawing figures. Before any particular embodiment of the invention is explained in detail, it must be made clear that the following details and illustrations of inventive concepts are mere examples of the many possible manifestations of the invention. It will be further appreciated that, while the present discussion relates primarily to apparel and other consumer goods. the system disclosed herein is not so limited. The invention may be readily applied to services and other goods industries beyond the apparel business.

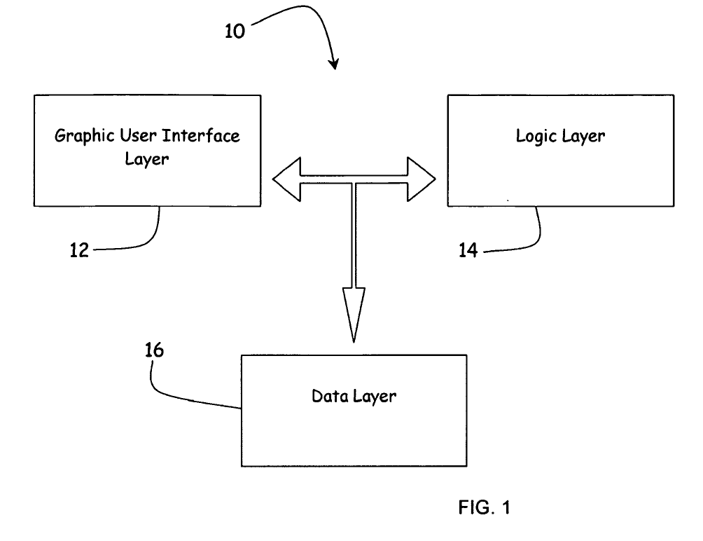

Turning more particularly to the drawings, a selection and shopping system pursuant to the present invention is indicated generally at 10 in FIG. 1. There, an embodiment of the system 10 can be seen to be founded on what can be schematically described as a first tier comprising a graphic user interface (GUI) 12, a second tier comprising a logic layer 14, and a third tier comprising a data layer 16. Embodiments of the system 10 can be created using open source programming and code to be fully compatible and fully compliant with all operating systems (OS). The graphic user interface 12, the logic layer 14, and the data layer 16 cooperate to enable mobile and other users of the system 10 to obtain personalized recommendations of goods, such as apparel items, or services and, if desired, to purchase such goods or services in a convenient, mobile environment. With the system 10, a consumer can develop and supplement his or her collection of goods or services consistent with personal characteristics and preferences, such as by developing and supplementing a wardrobe consistent with individualized sizing, purchasing, and fashion preferences. As taught herein, a consumer can retain and display his or her entire collection, such as an entire wardrobe, or just a selected portion thereof in a digital, readily accessed and adjusted format.

The graphic user interface 12 can be displayed initially in the browser window of a user's personal computer or web-enabled mobile device. The graphic user interface (GUI) 12 preferably occupies a small memory footprint and demonstrates a fast load time while retaining both a graphically inviting look and feel and an easily navigated menu. The system 10 can intuitively recognize the browser connection and can display an appropriate graphic user interface 12. If the requesting system is a desktop or laptop, a full web page application can be triggered. However, if the connecting system is a mobile device, a mobile web page of the system 10 can be triggered. While any method for detecting browser types would be within the scope of the invention, one embodiment of the invention contemplates use of a scripting language, such as Javascript® or any other scripting language or other means for enabling an automated distinction between the browser types of connecting systems. With the browser type recognized, the system 10 can respond by sending content pursuant to the operating system in use, such as Windows® or Apple® for desktops and laptops or any type of mobile operating system that might now exist or be hereafter developed.

It will be recognized that mobile devices under the present invention can be of any effective type, including, by way of example and not limitation, web-enabled mobile telephones, personal digital assistants, and any other operable device that might now exist or hereafter be developed. The mobile web page employs simple yet effective navigation to minimize load time and to require limited page refreshes. In certain embodiments, for example, effective navigation can be facilitated by employing graphics to replace questions driven by radio boxes. Furthermore, cache storage can record and save user progress and status, such as by recording progress deriving from user responses to questions and requests and by recording where the user has left off.

Even further, as discussed further below, the use of vector graphics can lessen the required data size while preserving and protecting graphic quality. Systems according to the invention can exploit advanced technology platforms, such as the Web 2.0 platform, to enable the full web pages and mobile web pages to operate interactively and not merely as static web pages. In certain practices of the invention, a link can enable a user to toggle to and from a mobile view thereby enabling one to check or access a mobile interface from a personal computer.

Any mobile device can be employed under the system 10, including. by way of example. a cellular telephone. a personal digital assistant. or any other effective mobile device. The system will, of course, ideally exploit the most advanced computer technology available. For example, at present, fourth-generation cellular communication systems, commonly referred to as 4G, are considered advanced. 4G cellular communication systems are fully IP-based integrated systems and networks achieved after the convergence of wired and wireless networks as well as computer, consumer electronics, communication technology, and several other convergences that will be capable of providing 100 Mbps and 1 Gbps, respectively, in outdoor and indoor environments with end-to-end QoS and high security, offering any kind of services anytime, anywhere. The Wireless World Research Forum (WWRF) defines 4G as a network that operates on Internet technology, combines it with other applications and technologies such as Wi-Fi and WiMAX, and runs at speeds ranging from 100 Mbps, such as in cell-phone networks, to 1 Gbps, such as in local Wi-Fi networks. 4G is not just one defined technology or standard, but rather a collection of technologies and protocols to enable the highest throughput, lowest cost wireless network possible.

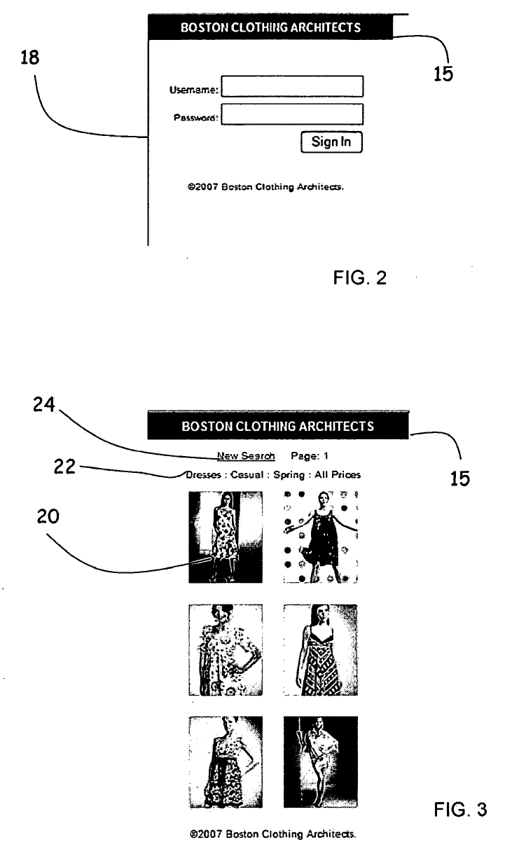

An example of an initial login page 18 for registered users for use in relation to a mobile device display screen 15 is shown in FIG. 2. There, a user can enter his or her username and password and can click “Sign In” to gain access to the system 10. Once signed in, the user can initiate a search for a desired article. The results of an exemplary search are depicted in FIG. 3. There, a plurality of search results 20, in this case photographs of women's casual spring dresses, are depicted on the display screen 15. The results page includes a summary 22 of the search query, and a link 24 for initiating a new search.

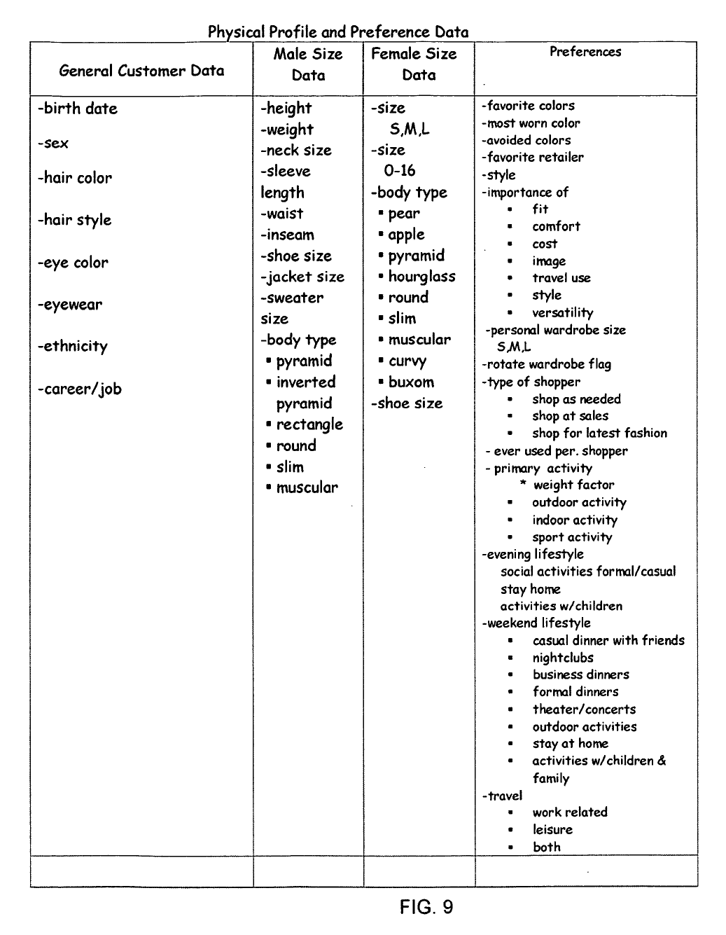

As will be described more fully herein, the search results can include only items corresponding to or most closely suiting the user's personal preferences as determined entirely or in part by the user's Personal Profile Questionnaire data of FIG. 8 and the user's physical profile as established pursuant to FIG. 9. Of course, the information produced in response to the Personal Profile Questionnaire and the Physical Profile and Preference Data can be established through a single set of inquiries or through multiple separate inquiries. The search can be further limited by price, availability, store location, and, additionally or alternatively, any other variable. Where desired, such as in shopping for another person, a user can disable some or all of his or her characteristics or preferences established, for example, through the user's Personal Profile Questionnaire, Physical Profile, and Preference Data.

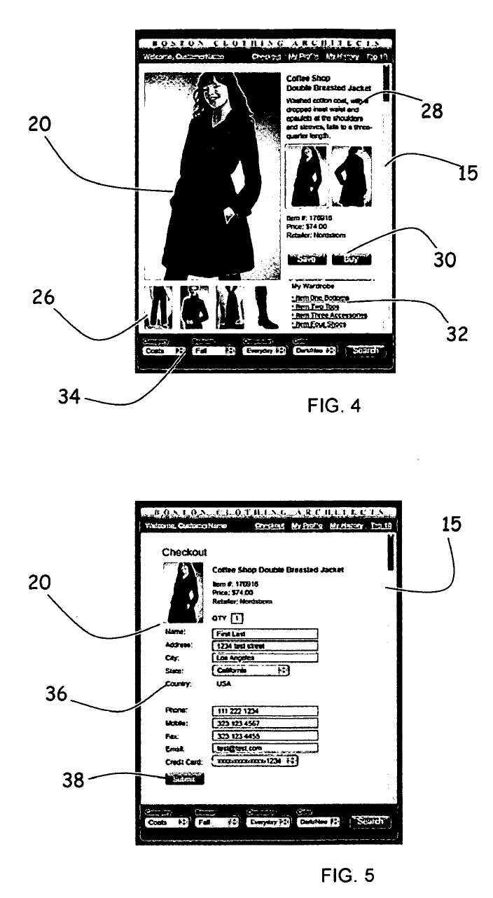

In FIG. 4, further information is provided on the display screen 15 in relation to a single search result 20 in response to a user's selection of the same, such as from a plurality of search results 20 retrieved in response to a search query. As shown, the system 10 can provide further details 28 regarding the search result 20, such as information relating to materials, manufacturer, designer, price, and the like. Furthermore, additional apparel items 26 can be displayed adjacent to or with the search result 20. For example, as taught hereunder, the system 10 can provide automatically coordinated suggestions as to apparel items 26 that could be worn with the search result 20. Alternatively or additionally, the system 10 can retain a virtual record of a user's collection 32 of goods or services, such as a wardrobe 32, whereby a user can display items already owned by him or her in relation to a proposed purchase to evaluate and assess coordination of the proposed purchase with items in the collection and the user's need for the item.

The display screen 15 can additionally include selection buttons 30 for enabling a purchase of an item, a saving of the search result 20 for future reference, or other functions. Still further, the single search result 20 page can provide one or more search parameters 34, such as color, occasion, style, and the like, that can be varied individually. In response to a user's pressing of a purchase selection button 30, a checkout page can be shown on the display screen 15 for enabling the purchase of a search result 20 as shown in FIG. 5. The checkout page can include a display of the search result 20 to be purchased along with the ordering information 36 of the purchaser. As shown, the ordering information 36 can include the purchaser's contact and payment information. Finally, a submission button 38 can initiate the actual purchase of an item under the system 10.

With further reference to FIG. 1, a logic layer 14, which can be considered a second tier of the system 10, can be associated with the graphic user interface 12. The logic layer 14 can, in many respects, be considered the core of the system 10. In certain embodiments, the logic layer 14 can be written in open source code, such as Python™ programming software. As such, the logic layer 14 can “see” the data in the database as objects and not just as a table of data items. The logic layer 14 can enable the creation of objects that “wrap up” and make accessible various types of data stored in database tables. The logic layer 14 treats data as “objects,” each with multiple attributes.

The logic layer 14 can read and write data from the database and manipulate the data to match items to the client's search query based on the information and style preferences already stored in the data layer. With this, the system 10 can operate as a truly intuitive search engine. All necessary searching to match the user with the appropriate choice of retailers and goods or services can be done automatically.

The logic layer 14 can also process orders based on a pre-determined methodology, which can be established entirely or in part with retailers. Order acknowledgement and tracking can keep customers up to date on purchases. The digital wardrobe 32 or other collection 32 of goods or services can maintain a living inventory of a user's collection. In addition to enabling coordination of already- owned items or already procured services with prospective purchases, the digital wardrobe 32 or other collection 32 can facilitate re-purchasing of items or the re-acquiring of services and, possibly. insurance adjustment should the user experience a loss of personal property, such as due to theft, misplacement, or a natural disaster. As such, the system 10 provides smart shopping support based on an acquired knowledge of a person's characteristics and preferences and on items already owned.

Again with reference to FIG. 1, a data layer 16, which can be considered a third tier of the system 10, can be operably associated with the graphic user interface 12 and the logic layer 14. The data layer 16 can store all information required by the logic layer 14 to process search queries and can retain client information regarding billing, shipping, personal preference, physical characteristic or requirements, and other factors. Personal preferences and physical characteristics or requirements can be gathered upon registration and, additionally or alternatively, during operation of the system 10. For example, a user can complete a Personal Preference Questionnaire, such as the exemplary form depicted in FIG. 8, and the user can submit Physical Profile and Preference Data, such as that sought in the form of FIG. 9. As noted, the information sought in the Personal Preference Questionnaire and the Physical Profile and Preference Data form can be obtained in a single form or through a series of inquiries or in multiple, separate forms. Personal preference information can also be acquired in a progressive manner by tracking previous purchases.

The Personal Preference Questionnaire and the Physical Profile and Preference Data or any other means for enabling the acquiring of individualized data for individual users or groups of users form can enable not only an input of physical information and personal preferences but can also serve as guides to assist the client in assessing his or her own style and needs. Exploiting this information, the logic layer 14 of the system 10 can match service providers, retailers, and items to clients. Service providers and retailer's inventories can also be stored and classified in the data layer 16 as can order processing methodology and shipping and billing information. The system 10 can also enable a flagging of sale items and specially tagged items for individual users.

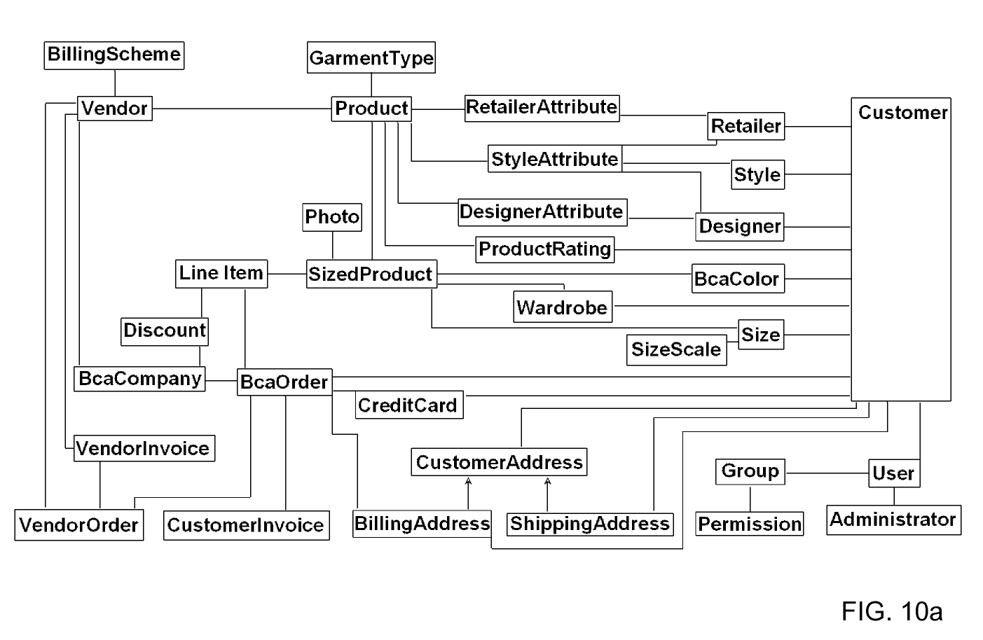

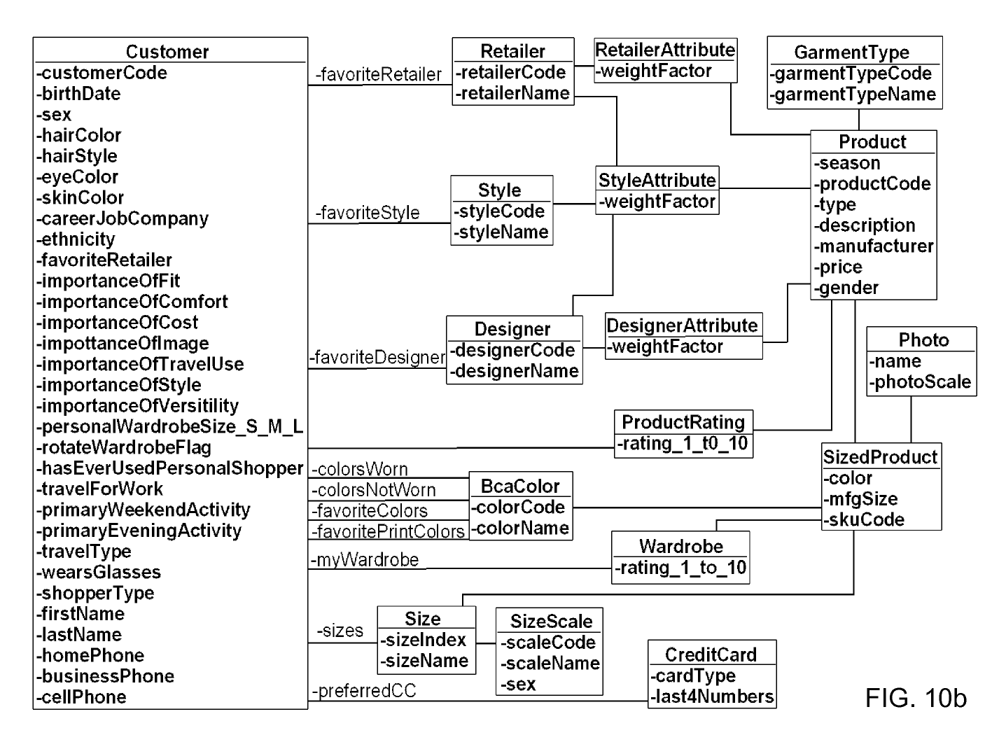

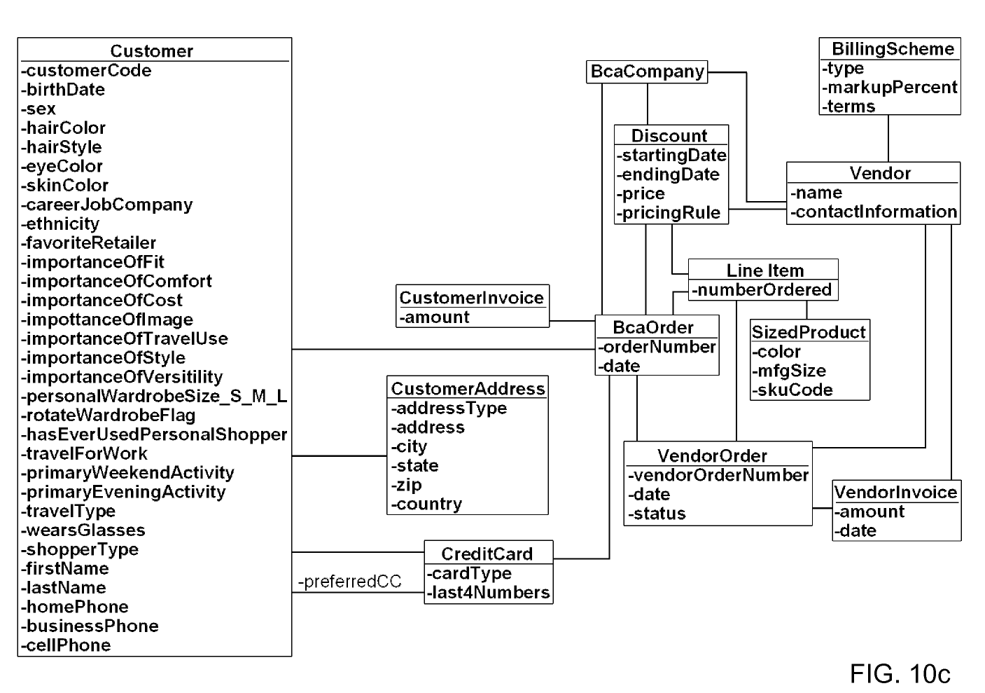

As shown in the schematic program depictions of FIGS. 10A through 10C, the system can be powered by a recommendation engine, which can be effectively interposed between a customer and potential search query results. In creating his or her profile, such as through previous purchases or through the Personal Preference Questionnaire, the Physical Profile and Preference Data form, or otherwise, a user can input preferences and characteristics, such as in relation to sizing, retailers, styles, designers, colors, and further characteristics. The descriptive options as to such preferences and characteristics can be predetermined by the system thereby to facilitate successful matching by the recommendation engine. In the drawings, which relate to a system 10 for use in relation to apparel, the preferences and characteristics are shown. for example, on the labeled lines between “Customer” and Retailer/Style/Designer/BcaColor. As such, the notation Indicates that a customer has a favoriteRetailer, a favoriteStyle, one or more “stylesILike”, and so forth.

When items are input into the system, vendors or other personnel can associate the new items with retailers, styles, sizing. designers, colors, and other identifying characteristics. In classifying a retailer, style. or designer, one may indicate not only that “this product was designed by designer X” or the like but also that “this product is similar to one that might have been designed by designer X”. A weighting accuracy factor of 0 to 10, for example, can be associated with this similarity. For example, a “0” can mean “designer X would never design something like this” while a “10” could mean “this looks exactly like something designer X would design”. Similarly, an item can be rated for style, such as by having an indication that “this product is rated 10 in similarity to the goth/punk style” and it is rated a 0weighting accuracy factor in similarity to business/casual style”. Where different designers and manufacturers are likely to have unique names for otherwise similar identifying characteristics, such as in relation to colors, items can be associated with pre-defined colors thereby to eliminate the difficulties that might derive from unique color names.

Again with reference to an exemplary use of the system 10 relative to apparel, customer sizing can be described as a set of “BcaSizeInfo” records with sizes attributed to shoes, shirts, and each other item to be included in the system 10. The number of size options can be as many as necessary to accommodate the type of article at hand, the gender for whom the item is intended, and other factors. Every product will be associated with a BcaSizeInfo record. Each BcaSizeInfo record will be tied either to a customer or to a product. With this, to find products that fit, the system 10 can search by garment type and look for products with BcaSizeInfo values that match up with the BcaSizeInfo values of the customer. The BcaSizeInfo mechanism enables a resolution of the problem of having no standard sizing across manufacturers, such as where a customer takes a size 8 blouse from Manufacturer A but a size 7 from Manufacturer B.

The digital collection 32 entity keeps track of things that a customer has purchased through the system 10 and, possibly, things that have been otherwise obtained. Under the system 10, items already retained in the collection 32 can be rated 1 to 10 on a preference or “I like” scale, and the system 10 can employ that preference scale as a factor in relation to the suggestion of further items in the recommendation engine. Furthermore, users can rate products that have not been purchased using a “ProductRating” entity, again on a 1 to 10 scale. Again, the system 10 can employ that “ProductRating” scale as a factor in relation to the suggestion of further items in the recommendation engine.

The system 10 can employ any suitable application framework. In one example of the system 10, a web application framework application, such as that sold under the trademark TurboGears™ of Kevin Dangoor, can be employed using a dynamic, object-oriented programming software, such as Python™ software of the Python Software Foundation. TurboGears™ includes a number of components including SQLAlchemy, which can be used to provide an interface between the database proper and the remainder of the application. Logic written in such an object-oriented programming software is effectively able to “see” the data in the database as an object and not merely a table of data items. Entities created in SQLAlchemy result in the creation of database objects that “wrap up” and make accessible various types of data stored in database tables.

For example, one might define a “Person” class in SQLAlchemy and match it up with a table in the database named “Person”. The database table can store a “Person” by, for example, first name and last name. The “Person” class can automatically read and write data from the database and manipulate the data. A routine in the “Person” class can take the first and last name bits of data and represent them in a particular way, such as by last name first, first name first, just the first initial and the last name, or any other suitable arrangement. With this, the “Person” class could produce “Samuel Adams”, “S. Adams”, or “Adams, Samuel” from data that is stored as two separate bits of information, firstName and lastName. Of course. other means for providing an interface between the database proper and the remainder of the application are possible and within the scope of the invention.

The logic layer 14 thus treats data as objects, each with multiple defined attributes. The system 10 can read and write the data in relation to the database and can manipulate and exploit the data layer 16 and the logic layer 14 to match goods and services to a user's query based on profile information acquired by the system 10 and stored in the data layer 16. Advantageously, all necessary searching and analysis to produce a match between a user's query and an appropriate search result is done automatically and nearly instantaneously.

The application framework can include a further component for assembling pages from the code software and for generating pages that can be delivered to a browser for display to users. For example, where TurboGears™ is employed, a “CherryPy” component can act as an engine to assemble pages from Python™ code and generating pages that can be delivered to a browser for display to users. facilitate operation of the system 10, each item that might potentially be retrieved will Ideally be tagged with appropriate descriptors. This can be done by any party or, theoretically, automatically by means that may now exist or hereafter be developed. As such, the tagging could be carried out by vendors, by designers, by users, by administrators of the system 10, or any other party or combination thereof.

The system 10 can exploit electronic data interchange (EDI) processes to enable the computer-to-computer exchange of ordering, shipping. payment, and other information. Under the EDI process, a user's order is translated into an EDI document format, commonly referred to as an 850 purchase order. The EDI 850 purchase order is then securely transmitted either via the Internet or through a Value Added Network (VAN). A buyer's VAN interconnects with a supplier's VAN to ensure that EDI transactions are sent and received. The system 10 can employ a computer system to process the order. With this, data security and control can be maintained throughout the transmission process using passwords, user identification and encryption, and the user's and the system's EDI applications can edit and check the documents for accuracy. Under the VAN approach, UPC catalogs can be delivered using “EDI 832” documents. Vendor's UPC catalog entries can be aligned with internal colors, sizes, and the like of the system 10 to enable a processing of the same.

Further embodiments of the system 10 could employ what has been referred to as Applicability Statement 2 (AS2), a draft specification standard by which vendor applications communicate EDI or other business-to-business data (such as XML) over the Internet using HTTP, a standard used by the World Wide Web. AS2 provides security for the transport payload through digital signatures and data encryption and ensures reliable, non-repudiable delivery through the use of receipts. AS2 applications can provide data compression.

The system 10 thus provides a shopping experience that allows consumers to develop a personal style and relationships with key retailers from their desktop, laptop, or mobile device. One can access the system 10 from anywhere in the world, at anytime, on any computer and on web-enabled mobile devices. Voice activation can be incorporated into the system 10 for enabling user's to input information and commands orally thereby eliminating the potentially frustrating need for inputting by key pressing.

The recommendation engine of the system 10 relates a user's profile as established above to items or services available for purchase. Under one embodiment of the invention, which can be considered to employ a tagging-intensive strategy, products or services available for purchase can be tagged according to predetermined system characteristics corresponding to consumer characteristics and desires, such as those provided in reply to the Personal Preference Questionnaire and the Physical Profile and Preference Data form and, possibly during previous purchases. With this, each product or service can be categorized pursuant to the attributes in the profile, such as “Personal Style”, “Primary Weekend Lifestyle”, and the like in relation to apparel.

A further embodiment of the invention alternatively or additionally employs a second strategy, which can be considered a more adaptive strategy. The adaptive strategy operates with less particularized tagging and requires identifications only of relative color. size. product type, and the like. Answers provided in reply to the Personal Preference Questionnaire and the Physical Profile and Preference Data form would be used, not as a way to tag products, but instead as a way to associate prospective consumer purchases or recommendations with purchases of other consumers sharing similar attributes with the shopper at hand. With this, recommendations can be provided according to what persons having similar characteristics have bought previously. For example, the system 10 could provide a recommendation as follows: “People who call themselves Chic buy a lot of product X. Therefore, recommend product X to other people who describe themselves as Chic”.

As the foregoing suggests, embodiments are contemplated wherein the adaptive strategy and the tagging-intensive strategy can be used in combination. With this, a hybrid recommendation engine can be produced. Certain recommendations can be provided entirely or partly based on a correspondence between a user's profile and tagged characteristics of products or services while certain other recommendations can be provided based on purchases of other buyers having assertedly similar characteristics. In any case, the recommendation engine could additionally or alternatively include tagging and search results 20 based in whole or in part on statistical information gleaned from one or more sources, such as marketing studies and retail customer taste statistics.

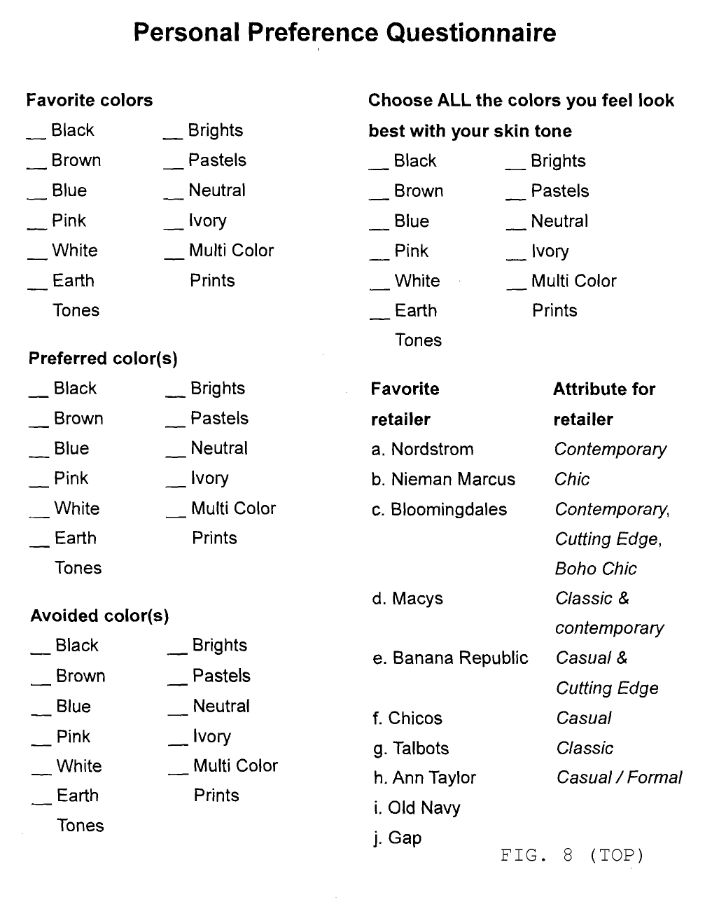

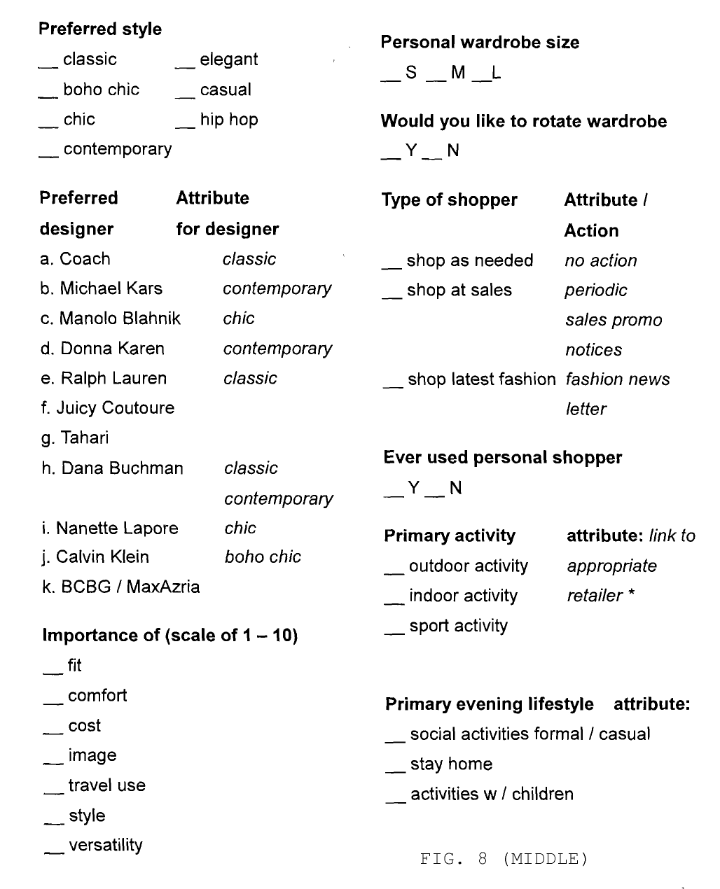

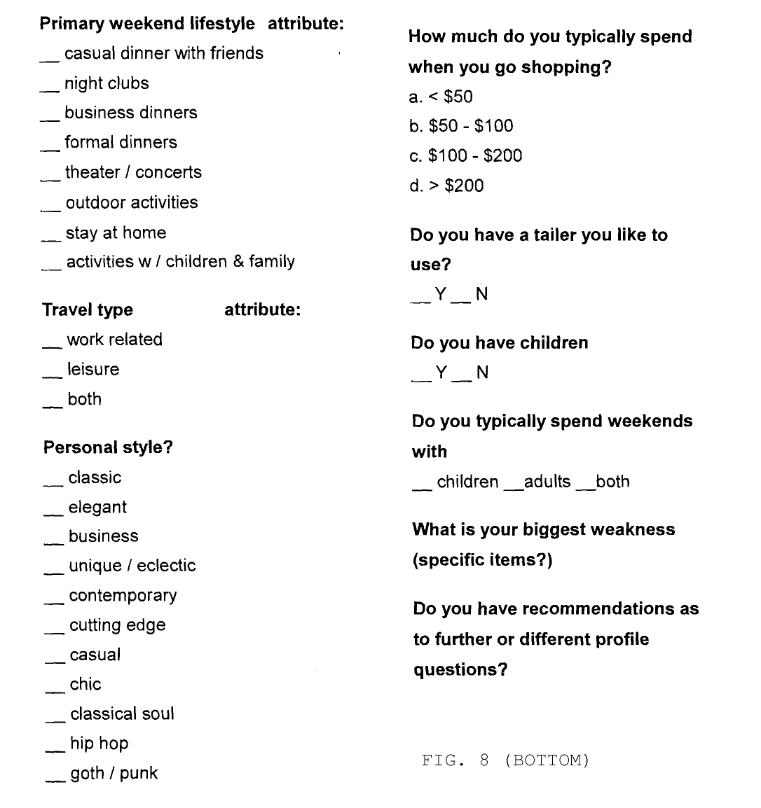

In an even further aspect of the invention, the system 10 could determine user attributes and provide search results based on vector analysis as exemplified in FIG. 7. There, vector V1 can be considered a first attribute, and vector v2 can be considered a second attribute. Vector V3 can be determined as a cross product of vectors V1 and V2 thereby enabling the formation of a unit and permitting a connection of the unit formed by vectors V1, V2, and V3 to other vector units formed by attributes and to larger systems of study.

It will be appreciated that. where an adaptive strategy is employed. there would be an issue with the introduction of new products into the system 10 in that they would have no purchasing history upon which recommendations can be based. Basing recommendations on past purchase histories would bias the results toward things that have already been sold; a newly offered product or service would not receive a recommendation. Therefore, the system 10 incorporates a means for automatically introducing new products or services into the search results 20 derived from adaptive searching methods. For example, each set of search results 20 can include at least one, a certain number, a percentage. or some other portion directed to newly added products or services. Once ordered or, possibly, once commented upon or otherwise tagged, products and services can be included in the adaptive strategy pool with other products and services. Of course, other methods for introducing new products and services into an adaptive system 10 would be possible and within the scope of the invention.

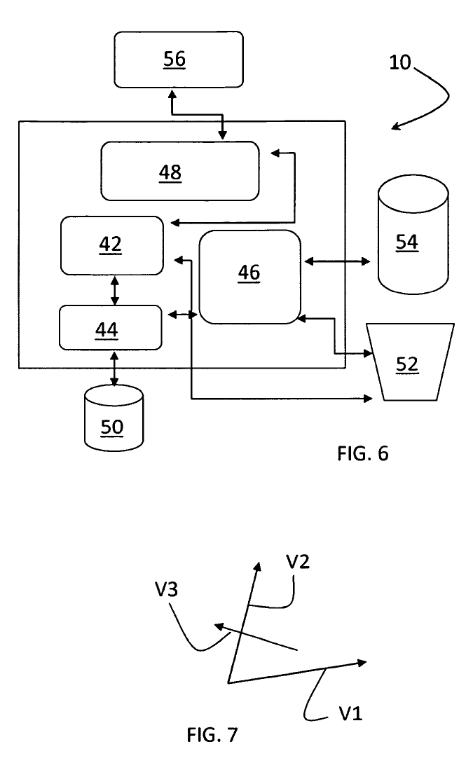

A more detailed schematic of a selection and shopping system 10 according to the invention is shown in FIG. 6. There, the system 10 is founded on the recommendation engine 42 as discussed above. A dynamic database detection module 46 enables the system 10 to detect the database being employed by the user. The system 10 can thus determine whether the user is storing its collection records in one of the popular database formats, such as SQL (Structured Query Language), or in a less common format. The system 10 can engage in an actual analysis of the targeted database. Additionally or alternatively, a simple file extension check could be employed. The database detection module 46 and the recommendation engine 42 can thus retrieve information from an external database 54, possibly by use of a non-standard implementation module 52. External profiles 50 can be retrieved through a profile processor 44 for insertion into the recommendation engine 42. A front end prebuffer 48, which can operate in html format can enable direct interaction with an end user's web browser 56.

So arranged, the recommendation engine 42. the front-end prebuffer 48, the dynamic database detection module 46, and the profile processor 44 can be considered to form a ‘black box’ where profile, collection, inventory, and other data are provided thereto and recommendations as to goods or services are received therefrom in an intelligent but automatic manner. The black box could be used with uniquely designed systems or plugged into existing search systems to improve the quality of existing queries. The system 10 thus provides the ability to handle a front-end interface through the prebuffer 48. The system 10 is also capable of handling dynamic external databases 54 by use of the dynamic database detection module 46 and the non-standard implementation module 52, which interacts with unknown or proprietary data sets, on both Input and output tasks. User profiles or other databases information can be pulled from external or internal sources, and the data is gauged dynamically and automatically by the auto-switching database detection module 46 such that the ‘black box’ would be able to process the majority of such datasets or profiles. Where the ‘black box’ is unaware of a dataset or profile format, the non-standard implementation module 52 can alternatively permit external handling of the data.

With certain details of the present invention disclosed, it will be appreciated by one skilled in the art that changes and additions could be made thereto without deviating from the spirit or scope of the invention. This is particularly true when one bears in mind that the presently preferred embodiments merely exemplify the broader invention revealed herein. Accordingly, it will be clear that those with certain major features of the invention in mind could craft embodiments that incorporate those major features while not incorporating all of the features included in the preferred embodiments.

Therefore, the following claims are intended to define the scope of protection to be afforded to the inventor. Those claims shall be deemed to include equivalent constructions insofar as they do not depart from the spirit and scope of the invention. It must be further noted that a plurality of the following claims express certain elements as means for performing a specific function, at times without the recital of structure or material. As the law demands, these claims shall be construed to cover not only the corresponding structure and material expressly described in this specification but also all equivalents thereof that might be now known or hereafter discovered.
We claim as deserving the protection of U.S. Letters Patent:

1. In a selection and shopping system that provides access to a database of items, a method for providing search results based on individualized user characteristics comprising the computer-implemented steps of:
retaining in computer memory an inventory of items available for purchase;
attributing identifying data to each of the inventory of items:
obtaining individualized profile data from each of a plurality of users:
retaining in computer memory the individualized profile data from each of the plurality of users;
accepting through remote electronic communication a search query from a user device regarding the inventory of items available for purchase;
determining a correspondence between items available for purchase and the search query based on the individualized profile data wherein the step of determining a correspondence between items available for purchase and the search query based on the individualized profile data is powered by a recommendation engine; and
providing a search result from the recommendation engine comprising a display on the user device of items from the inventory of items that have a correspondence with the search query and the individualized profile data.

2. The method of claim 1 wherein the step of obtaining individualized profile data comprises the step of receiving and inputting to memory data obtained from a profile questionnaire.

3. The method of claim 2 wherein the step of obtaining individualized profile data further comprises obtaining physical profile data from a user.

4. The method of claim 1 further comprising the step of retaining in computer memory data regarding a collection of items already possessed by a user.

5. The method of claim 4 further comprising the step of enabling a comparison of items within the collection of items with items from the search result.

6. The method of claim 1 wherein the step of accepting through remote communications a search query comprises accepting a search query over the Internet.

7. The method of claim 6 further comprising the steps of detecting a browser type of the user device and causing a graphic user interface to be displayed on the user device dependent on the recognized browser type whereby a mobile interface can be provided where a mobile browser type is detected and a desktop interface can be provided where a desktop browser type is detected.

8. The method of claim 7 wherein the step of detecting the browser type comprises applying a scripting language application for enabling an automated distinction between browser types.

9. The method of claim 8 further comprising the step of enabling a selective toggling between the mobile interface and the desktop interface at the user device.

10. The method of claim 1 further comprising the step of enabling a purchase of items through remote electronic communication from the user device.

11. The method of claim I wherein the recommendation engine employs a weighting accuracy factor for evaluating a correspondence between items in the inventory and a search query.

12. The method of claim 11 further comprising the step of assigning items included in the inventory system size identifications and inventory system color identifications wherein the inventory system size identifications and inventory system color identifications are standardized whereby the method can provide a standardized result independent of manufacturer size and color identifications.

13. The method of claim 11 further comprising the step of retaining in computer memory data regarding a collection of items already possessed by a user, wherein the individualized profile data includes a rating of items in the collection and wherein the recommendation engine evaluates items in the inventory based on the ratings of items in the collection.

14. The method of claim 1 further comprising the step of tagging items in the inventory with descriptors.

15. The method of claim 14 wherein the step of tagging items is performed manually.

16. The method of claim 14 wherein the step of tagging items is based on profile data of users.

17. The method of claim 16 wherein the step of tagging items comprises tagging items to correspond to characteristics identified in the profile data of users.

18. The method of claim 14 where the step of tagging items comprises attributing identifying information to items based on attributes of users who have purchased those items.

19. The method of claim 18 wherein the step of tagging items is based on profile data of users whereby a hybrid recommendation engine can be provided.

20. The method of claim 14 wherein the step of tagging is carried out in an adaptive format wherein untagged items of the inventory are included within search results and tagging is performed based on user input in response to the search results.

21. The method of claim 20 wherein the user input in response to the search results comprises a purchasing or non-purchasing of the item.
